(19) United States
(12) Patent Application Publication
(10) Pub. No.: US 2012/0285474 A1
(43) Pub. Date: Nov. 15, 2012

(54) FOLDABLE DUST MASK

(76) Inventor: Jerome S. Healy, Seattle, WA (US)

(21) Appl. No.: 13/103,343

(22) Filed: May 9, 2011

(51) Int. Cl. A62B 7/10

(52) U.S. Cl. 128/863

(57) ABSTRACT

A foldable dust mask having a foldable shell suitable for covering the nose and mouth of the wearer, a breathing aperture, and a filter patch overlying the breathing aperture on the foldable shell. The filter patch is constructed from a fibrous material sufficient for trapping air particulates, and is affixed to the foldable shell by an adhesive strip around the edges of the filter patch. The foldable shell is reusable, and is attached to the head of the wearer using a strap. An alternate embodiment of the foldable shell contains a chin loop, which can be used to hold a lanyard for ear protection devices.

The present invention relates to a foldable dust protection mask with a reusable shell, and disposable filter patches. More particularly, the foldable mask for dust protection can be shipped and stored flatly, and constructed on site, by folding the material into a shell, and apply a separate filter patch over the breathing aperture portion of the mask. The filter patch can then be removed and replaced, as necessary.

Large amounts of dust are generated in areas such as paper mills, textile factories, quarries, construction sites, etc. The continued inhalation of dust and other particulates in the air cause lead to respiratory diseases in the lungs, nose, and throat. Therefore, workers must wear a dust protective mask in order to protect themselves from these harmful substances. There are two basic types of dust protection masks. The first type is a reusable mask, whereby the filter and the shell are two separate pieces. This allows for the shell to be reused by removing and replacing the filter. These masks are typically much more expensive when compared to disposable masks, are more cumbersome for the wearer, and require periodic cleaning. The second type of conventional dust protection masks is a disposable, one-time use mask. These masks typically consist of a form fitting, semi-rigid, paper filter. However, these conventional dust protection masks all a number of limitations. They are single use only and they generally provide a poor seal around the nose area. In addition, such masks are not robust enough for use to withstand heavy industrial-type use due to their propensity for ripping or tearing, and are also susceptible to being crushed or ripped during shipment and storage. Finally, such masks cannot be shipped and stored flat, and thus require bulky containers which entail higher shipping and storage costs. What is needed is a dust mask which overcomes the above limitations. Accordingly, it is one object of the present invention to provide a dust protection mask that is inexpensive, provides a good seal around the nose and mouth areas, is reusable, and can easily be shipped and stored without risk of damage.

The dust protection mask of the present invention has two primary parts. The first part comprises a flat, semi-rigid, impermeable sheet that can be folded at the point of use into a shell. The second part is a filter patch that is applied to the shell. The shell may be reused by removing and replacing filter patches as they become fouled. The shell also provides for the installation of a string, elastic band, or some other material that can be attached to each side of the mask and to wrap around the head of wearer for securing the mask to the face of the wearer.

It is a further object of the invention to provide a method for assembling an inexpensive dust mask at the point of use. The method is simple and quick, even for users with no prior experience. The point of use can be at a construction site, factory, farm, mine or the like.

In the Figures:

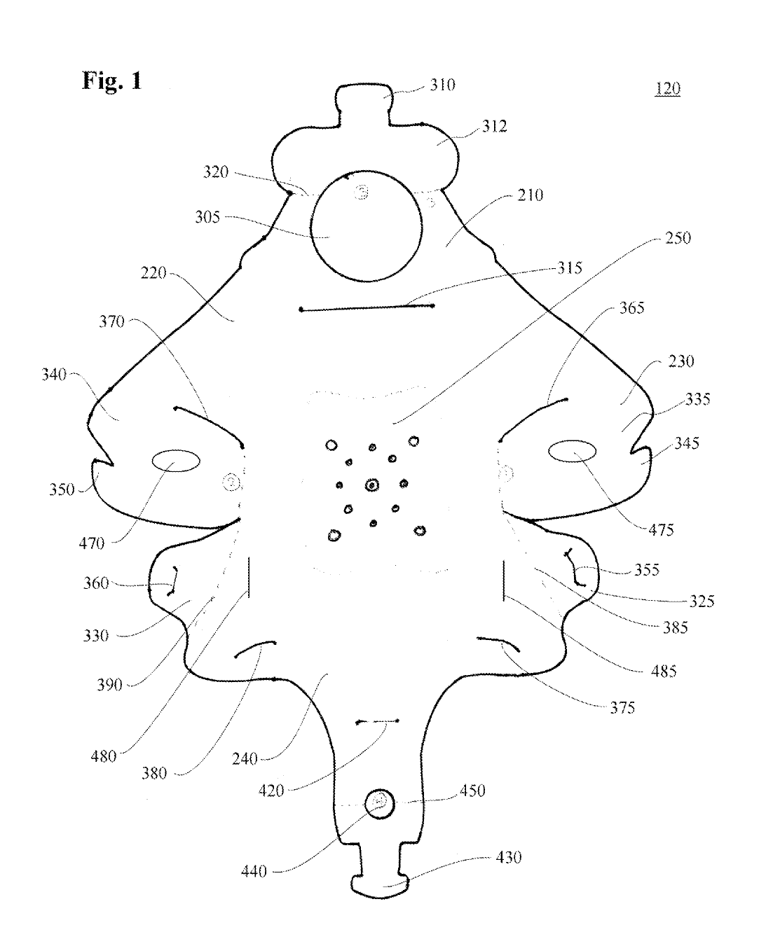

FIG. 1 is a plan view of the sheet in its unfolded state.

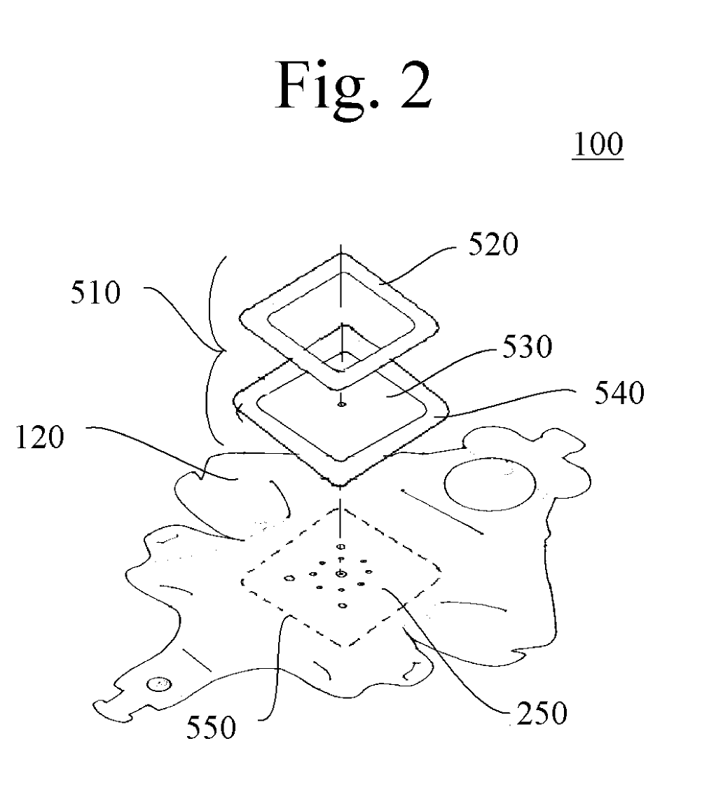

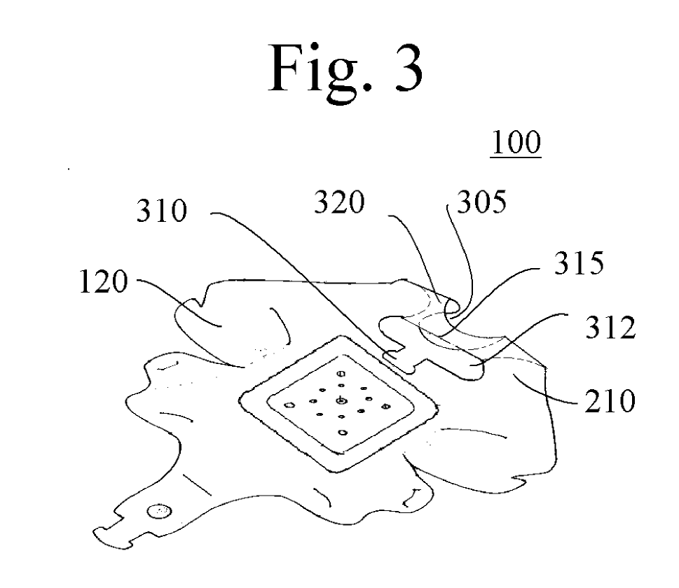

FIG. 2 is an exploded view of the foldable dust mask, showing the sheet and filter patch prior to assembly into the dust mask. FIG. 3 is a perspective view of the foldable shell demonstrating the folding of the nose section.

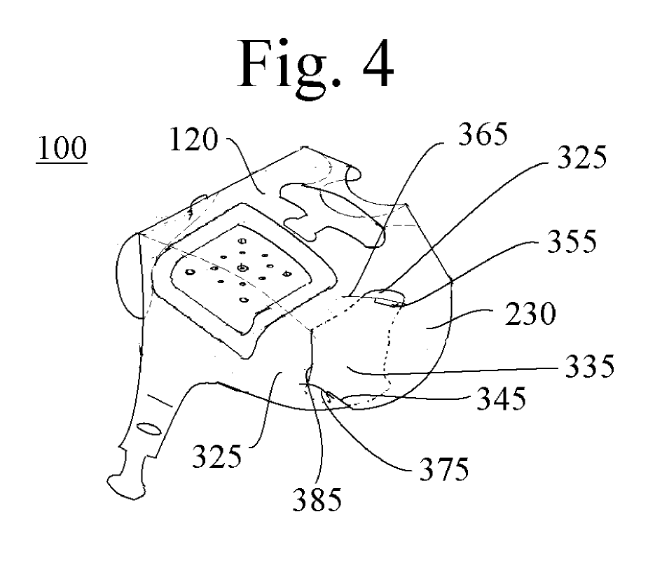

FIG. 4 is a perspective view of the foldable shell demonstrating the folding of the right cheek section.

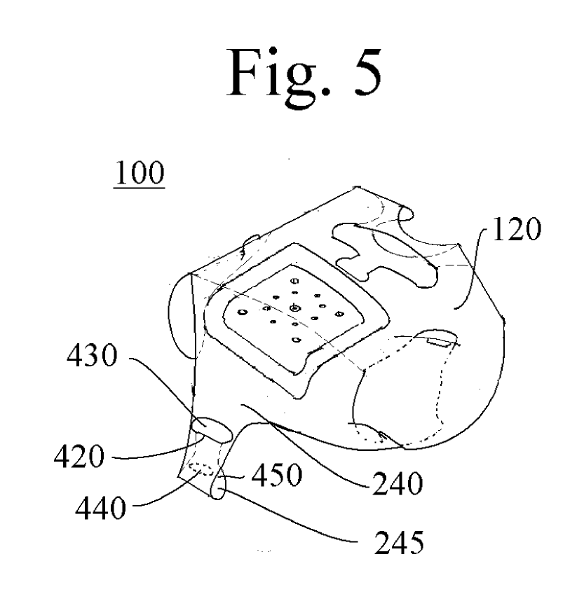

FIG. 5 is a perspective view of the foldable shell demonstrating the folding of the chin loop.

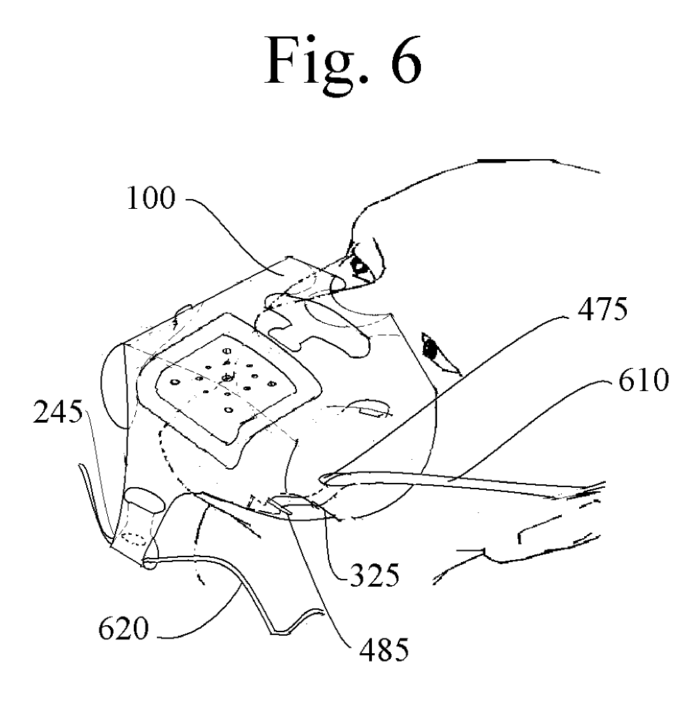

FIG. 6 is a perspective view of the mask as worn on the face of the wearer, secured with the holding strap, and with the chin loop containing a lanyard.

Now, turning to the Figures, FIG. 1 is a plan view of the sheet which is folded to form the shell portion, hereinafter referred to as the foldable shell 120, in its unfolded state. There are 5 major sections of the shell part: nose section 210, left cheek section 220, right cheek section 230, chin section 240, and breathing aperture 250. In alternate embodiments, the breathing aperture 250 may contain a filter patch locating guide 550 to assist with the placement of the filter patch.

The material selected for the foldable shell 120 should be impermeable to airborne dust particles. In addition, the material selected must have the proper combination of strength and thickness to permit folding without fracturing, but with enough rigidity that the shell won't collapse onto the face when the wearer inhales. One suitable material is polycarbonate sheet with a thickness of approximately 0.010 inch. An even more preferable material is a biodegradable plastic wheet which can be discarded after use with minimal environmental harm. The shape and features of the sheet 120 may be molded, cut, or stamped as appropriate for the selected material. In a preferred embodiment, the sheet is about 10 inches long in a longitudinal axis and about 7 inches wide in a cross axis. Such a size has been discovered to fit a sizable portion of the expected wearer population.

The nose section 210 comprises a number of features. A nose section aperture 305 is disposed near the center of the section. A horizontal cut through the foldable shell 120, hereinafter referred to as the nose section locking slot 315, is disposed below the Nose Section Aperture 305. A “T”-shaped portion, hereinafter referred to as a locking tab 310, is disposed at the top of nose section. One or more nose section locking tab wings 312 are disposed between the nose section locking tab 310 and the nose section aperture 305. As will be shown in further detail, the nose section aperture 305 provides for a comfortable fit in the area where the nose section contacts the bridge of the nose, as well as providing a form-fitting seal over the bridge of the nose. An alternate embodiment contains an additional locking slot disposed adjacent to locking slot 315. The additional locking slot, which is not illustrated, is similarly configured locking slot 315, and allow for sizing the foldable shell to better fit the face of the wearer. The nose section folding region 320 is in the area of the nose section aperture 305.

The left cheek section 220 can be broken down into two primary parts, a left cheek section upper flap 340 and a left cheek section lower flap 330. The left cheek section folding region 390 is shown along an interior boundary of the left cheek section 220.

The left cheek section upper flap 340 serves as the outer left portion of the formed shell of the dust mask 100. The upper flap 340 comprises the following features: a notch cut out along the lower, outside edge, hereinafter referred to as a left cheek section hook 350; an aperture disposed in the upper middle area of the left cheek section upper flap 340, hereinafter referred to as a left head strap holder 470; and a cut through the foldable shell 120 material, hereinafter referred to as a left cheek section locking slot 370. The angle and position of the left cheek section locking slot 370 allows the left cheek section lower flap 330 to line up and slide into it when folded.

The left cheek section lower flap 330 comprises the following features: a cut through the foldable shell 120 material near the outside edge of the left cheek section lower flap 330 creating a tab shape, hereinafter referred to as left cheek section locking tab 360; a cut through the material near the bottom edge of the left cheek section lower flap 330, hereinafter referred to as a left cheek section hook slot 380, a vertical cut (i.e. in the longitudinal axis of the sheet) disposed above the left cheek section hooking slot, hereinafter referred to as a left head strap lock 480.

The right cheek section 230 is generally the minor image of the left cheek section 220. Right cheek section 230 thus includes two primary parts, a right cheek section upper flap 335 and a right cheek section lower flap 325. The right cheek section folding region 385 is shown along an interior boundary of the right cheek section 230.

The right cheek section upper flap 335 serves as the outer right portion of the formed shell of the dust mask 100. The upper flap 335 comprises the following features: a notch cut out along the lower, outside edge, hereinafter referred to as a right cheek section hook 345; an aperture disposed in the upper middle area of the right cheek section upper flap 335, hereinafter referred to as a right head strap holder 475; and a cut through the foldable shell 120 material, hereinafter referred to as a right cheek section locking slot 365. The angle and position of the right cheek section locking slot 365 allows the right cheek section lower flap 325 to line up and slide into it when folded.

The right cheek section lower flap 325 comprises the following features: a cut through the foldable shell 120 material near the outside edge of the right cheek section lower flap 325 creating a tab shape, hereinafter referred to as right cheek section locking tab 355; a cut through the material near the bottom edge of the right cheek section lower flap 325, hereinafter referred to as a right cheek section hook slot 375, a vertical cut (i.e. in the longitudinal axis of the sheet) disposed above the right cheek section hooking slot, hereinafter referred to as a right head strap lock 485. Chin section 240 includes three primary features: a horizontal (i.e in the latitudinal direction) slot near an interior boundary of the chin section 240, hereinafter referred to as a chin loop locking slot 420; an inverted, “T”-shaped tab extending downward vertically at the bottom edge of the chin section 240, hereinafter referred to as a chin loop locking tab 430; and an aperture between the chin loop locking tab 430 and chin loop locking slot 420, hereinafter referred to as a chin loop aperture 440. The chin loop fold region 450 lies generally along the line forming the horizontal axis of the chin loop aperture 440.

FIG. 2 is an exploded perspective view of the entire foldable dust mask 100. The dust mask 100 includes two main parts: the foldable shell 120 and a filter patch 510. The filter patch 510 is constructed with a filter material suitable for trapping airborne particulates, hereinafter referred to as filter material 530, an adhesive strip 520 around the periphery of the filter material 530, and an adhesive liner 540 that is peeled off to expose the adhesive on the adhesive strip 520 prior to affixing over the breathing aperture 250. The filter patch 510 should be of sufficient size to completely overlay the breathing aperture 250 even if the filter patch 510 should be placed somewhat off-center from the breathing aperture 250. The breathing aperture 250 on the foldable shell 100 includes an optional filter patch locating guide 550 disposed around the breathing aperture 250 to assist in the proper placement of the filter patch 510.

FIG. 3 is a perspective view of the foldable shell 120 depicting the nose section 210 in its folded position. The nose section 210 is constructed by bending the foldable shell at the nose section fold region 320, with the nose section locking tab 310 folded under toward an interior side (i.e. wearer-facing side) of the nose section 210, and by feeding the nose section locking tab 310 and nose section locking tab wings 312 through the nose section locking slot 315 to secure the fold. Alternate embodiments include more than one nose section locking slot 315, not illustrated, the nose section locking slot 315 that provides an adjustable fit for various-sized wearer's faces.

It can be seen from the FIG. 3 illustration that the exterior facing side of the foldable shell 120 which is adjacent to the nose section aperture 305 serves as a resting surface ove the bridge of the wearer's nose. The resting surface is large enough and flexible enough to provide an adequate seal while retaining wearer comfort.

FIG. 4 is a perspective view of the foldable shell 120 depicting the right cheek section 230 in its folded position. The right cheek section 230 is formed by folding and rotating the right cheek section lower flap 325 along the right cheek section folding region 385 underneath the right cheek section upper flap 335. The assembly is locked into shape in a two-fold manner. First, the right cheek section locking tab 355 engages into the right cheek section locking slot 365, while hooking the right cheek section locking tab 355 over the bottom edge of the right cheek section locking slot 365. Second, the right cheek section hook 345 is inserted into the right cheek section hook slot 375.

The left cheek section 220 is constructed and formed in a mirror image to the right cheek section 230 of FIG. 4. FIG. 4 also depicts the left cheek section 220 of the foldable shell 120 in its folded position. The left cheek section 220 is formed by folding and rotating the left cheek section lower flap 330 along the cheek section folding region 390 underneath the left cheek section upper flap 340. The assembly is locked into shape in a two-fold manner. First, the left cheek section locking tab 360 engages into the left cheek section locking slot 370, while hooking the left cheek section locking tab 360 over the bottom edge of the left cheek section locking slot 370. Second, the left cheek section hook 350 is inserted into the left cheek section hook slot 380.

FIG. 5 is a perspective view of the foldable shell 120 depicting the chin loop 245 in its folded position. The chin loop 245 is constructed by folding the chin loop locking tab 430 under at the chin loop fold region 450 toward the inside of the foldable shell 120. The chin loop 245 is held in shape by the insertion of chin loop locking tab 430 into the chin loop locking slot 420. The chin loop 245 and/or chin loop aperture 440 can be used to hold a lanyard for ear protection devices and the like.

FIG. 6 is a perspective view of the foldable dust mask 100 secured over the nose and mouth of the wearer. A head strap 610 holds the dust mask 100 in place. The head strap can be made of any sufficiently elastic material, including string, rubber band, or a strip of fabric or plastic, which is sufficient for securing the foldable dust mask (100) over the nose and mouth areas of the wearer with enough sealing force through normal work activities. The head strap 610 is attached at each end to the foldable shell 120 by threading one end through the left head strap holder 470, and securing in the left head strap lock 480. The other end of the head strap 610 is threaded through the right head strap holder 475 and secured in the left head strap lock 485. FIG. 6 also shows that each end of head strap 610 may optionally be secured in the slot formed by the folding of the cheek lower flaps 325, 330 under the cheek upper flaps 335, 340 in order. The wearer then places the foldable dust mask 100 over the nose and mouth areas. The wearer may adjust the tightness of the dust mask 100 by pulling on either end of the head strap 610.

FIG. 6 also illustrates that the chin section 240 containing a lanyard 620 which is threaded through the chin loop 245. The lanyard 620 is optional and is not a particular part of the present invention. The chin loop 245 and/or the chin loop aperture 440 can thus be used to hold ear protection devices or other small items when not being worn in order to prevent them from falling to the ground and being dirty or lost.

FIGS. 2 through 6 and their corresponding descriptions also illustrate a method for folding and assembling a dust mask for use. The method may be completely accomplished at the point of use by the wearer. An advantage of the present invention is thus realized by enabling the unassembled mask to be shipped flat, i.e. cheaply and efficiently. Another advantage in the method is that the foldable shell 120 may be reused several times. The inexpensive filter patch 510 is the only replacement part. Finally, the flexibility of the head strap attaching structure allows for many materials that are commonly available at the worksite to be used as the head strap 610.

To summarize the method described by FIGS. 2 through 6, the steps of assembling the dust mask 100 comprise the steps of providing a flat semi-rigid sheet having a shape for forming into a shell and a breathing aperture, providing an adhesively attached filter patch, folding the sheet into a shell, and adhesively affixing the filter patch to the shell overlying the breathing aperture. The folding steps further comprise folding the left and right cheek sections, the nose section, and the chin section. A head strap may be attached and then adjusted after the mask is formed. No particular order for the steps is otherwise called for. After use, the filter patch may become fouled with filtered dust. The user may simply remove the dirty patch and replace the filter patch with another. Once the work is completed, the entire assembly may be discarded, or the shell assembly can by unfolded and stored for re-use.

Alternate arrangements of the foldable dust mask as illustrated by FIGS. 1 through 6 are envisioned which fall within the scope of the claimed invention. For example, the material selected for the shell 120, filter patch 510 and headstrap 610 can be modified to suit the needs of the manufacturer or wearer. The particular folding and locking structures also may vary within the scope of the invention.

1. A foldable dust mask for protecting a wearer from airborne particulates comprising:
a foldable shell having a breathing aperture; and
a filter patch disposed over the foldable shell breathing aperture, and sealed around the periphery of the breathing aperture.

2. The foldable dust mask of claim 1 wherein the foldable shell further comprises:
a nose section;
a chin section adapted to fit under the chin of the wearer;
a left cheek section adapted to overlie the left cheek of the wearer;
a right cheek section adapted to overlie the right cheek of the wearer; and
a means for holding the foldable shell over the nose and mouth of the wearer.

3. The foldable dust mask of claim 2 wherein the nose section further comprises:
a nose section aperture that when folded over conforms to the bridge of the wearer's nose;
a nose section locking tab disposed at the top of the nose section;
a nose section locking tab wing disposed between the locking tab and the nose section aperture; and
a nose section locking slot disposed below the nose section aperture for slidably receiving the nose section locking tab and nose section locking tab wing,
whereby the locking tab is folded into an interior side of the foldable shell, and threaded through the nose section locking slot to hold the nose section aperture in the folded over position.

4. The foldable dust mask of claim 1 wherein the foldable shell is comprised of a biodegradable plastic.

5. The foldable dust mask of claim 2 wherein the chin section further comprises:
a chin loop locking slot;
a chin loop locking tab with a hook on each side disposed at the edge of the foldable shell; and
a chin loop aperture disposed between the chin loop locking tab and the chin loop locking slot,
whereby the chin loop locking tab is folded into an interior side of the foldable shell and threaded into the chin loop locking slot to form a chin loop.

6. The foldable dust mask of claim 2 wherein the left cheek section further comprises:
a left cheek upper flap having a left cheek locking slot, and a left cheek hook; and
a left cheek lower flap with a left cheek hook slot, and a left cheek locking tab,
whereby the left cheek lower flap is disposed to be folded under the left cheek upper flap and through the left cheek locking slot, and further whereby the left cheek hook is disposed to be engaged into the left cheek hook slot,
and further whereby the left cheek locking tab is disposed to be engaged into the left cheek locking slot to hold the left cheek section in a folded position.

7. The foldable dust mask of claim 2 wherein the right cheek section further comprises:
a right cheek upper flap having a right cheek locking slot, and a right cheek hook; and
a right cheek lower flap with a right cheek hook slot, and a right cheek locking tab,
whereby the right cheek lower flap is disposed to be folded under the right cheek upper flap and through the right cheek locking slot, and further whereby the right cheek hook is disposed to be engaged into the right cheek hook slot,
and further whereby the right cheek locking tab is disposed to be engaged into the right cheek locking slot to hold the right cheek section in a folded position.

8. The foldable dust mask of claim 1 wherein the breathing aperture further comprises a filter patch locating guide disposed around the periphery of the breathing aperture.

9. The foldable dust mask of claim 2 wherein the means for attaching the foldable shell is selected from the group consisting of a rubber band, a string, a strip of fabric, and a strip of plastic.

10. The foldable dust mask of claim 1 wherein the filter patch further comprises:
a layer of filter material; and
an adhesive strip disposed around the periphery of the filter material,
whereby the adhesive strip affixes the filter patch to the foldable shell such that the layer of filter material overlies the breathing aperture.

11. The foldable dust mask of claim 10, wherein the layer of filter material is a carbon filter.

12. A method for assembling a foldable dust mask comprising the steps of:
providing a flat semi-rigid sheet having a shape for forming into a shell and a breathing aperture;
providing an adhesively attached filter patch;
folding the sheet into a shell; and
adhesively affixing the filter patch to the shell overlying the breathing aperture.

13. The method for assembling a foldable dust mask of claim 12 wherein the step of folding the sheet into a shell further comprises:
folding a left cheek section;
folding a right cheek section;
folding a nose section; and
folding a chin section.

14. The method for assembling a foldable dust mask of claim 13 wherein the step of folding the nose section further comprises:
folding a nose section locking tab to an interior side of the sheet; and
inserting the nose section locking tab into a nose section locking slot.

15. The method for assembling a foldable dust mask of claim 13 wherein the step of folding the right cheek section further comprises:
folding a right cheek lower flap under a right cheek upper flap; and
locking the right cheek upper and lower flaps together using a right cheek hook and a right cheek locking tab.

16. The method for assembling a foldable dust mask of claim 13 wherein the step of folding the chin section further comprises the steps of:
forming a chin loop by folding a chin loop locking tab disposed at a bottom edge of the foldable shell into a loop; and
inserting the chin loop locking tab into a chin loop locking slot.

17. The method for assembling a foldable dust mask of claim 12 further comprising the steps of:
removing the filter patch from the shell after the adhesively affixing step; and
placing a second filter patch over the breathing aperture after the removing step.

18. The method for assembling a foldable dust mask of claim 12 further comprising the steps of:
providing a means for attaching the dust mask over the nose and mouth of a wearer; and
attaching the means for attaching to a left cheek section and a right cheek section of the shell.

19. The method for assembling a foldable dust mask of claim 18, wherein the step of attaching further comprises:
lockably threading the means for holding into a strap holder and strap lock disposed on the right cheek section; and
lockably threading the means for holding into a strap holder and strap lock disposed on the left cheek section.

20. The method for assembling a foldable dust mask of claim 18, wherein the means for attaching is selected from the group consisting of a rubber band, a string, a strip of fabric, and a strip of plastic.
